(19) United States
(12) Patent Application Publication
(10) Pub. No.: US 2016/0216661 A1
(43) Pub. Date: Jul. 28, 2016

(54) IMAGE FORMING APPARATUS AND MEDIUM STACKING DEVICE

(71) Applicant: FUJI XEROX CO., LTD., Tokyo (JP)

(72) Inventors: Tatsuhiro IGARASHI, Kanagawa (JP); Yoshinari UENO, Kanagawa (JP); Manabu FURUKI, Kanagawa (JP); Masahiro UCHIDA, Kanagawa (JP); Masashi IKEDA, Kanagawa (JP); Mona TASAKI, Kanagawa (JP); Teppei YAWADA, Kanagawa (JP)

(21) Appl. No.: 14/857,117

(22) Filed: Sep. 17, 2015

(30) Foreign Application Priority Data
Jan. 26, 2015 (JP) 2015-012006

(51) Int. Cl. G03G 15/20

(52) U.S. Cl. CPC G03G 15/2028

(57) ABSTRACT

An image forming apparatus, includes a forming device that forms unfixed images on recording media, a fixing unit that melts a material forming the images to fix the images onto the recording media, a stacking tray on which the recording media onto which the images are fixed are stacked, and a displacer that applies a force to the recording media stacked on the stacking tray to displace the recording media relative to each other.

### CROSS-REFERENCE TO RELATED APPLICATIONS

This application is based on and claims priority under 35 USC 119 from Japanese Patent Application No. 2015-012006 filed Jan. 26, 2015.

### BACKGROUND

(i) Technical Field

The invention relates to an image forming apparatus and a medium stacking device.

(ii) Related Art

In the related art, an image forming apparatus which forms an image on a recording medium with a toner is known.

### SUMMARY

According to an aspect of the invention, there is provided an image forming apparatus, including: a forming device that forms unfixed images on recording media;

a fixing unit that melts a material forming the images to fix the images onto the recording media;

a stacking tray on which the recording media onto which the images are fixed are stacked; and

a displacer that applies a force to the recording media stacked on the stacking tray to displace the recording media relative to each other.

### BRIEF DESCRIPTION OF THE DRAWINGS

Exemplary embodiments of the present invention will be described in detail based on the following figures, wherein:

FIG. 1 is a schematic configuration diagram of a printer corresponding to a first exemplary embodiment of an image forming apparatus;

FIG. 2 is a schematic configuration diagram of a separation mechanism which is provided in a paper stacker;

FIG. 3 is a diagram illustrating a first stage of a separation operation;

FIG. 4 is a diagram illustrating a second stage of the separation operation;

FIG. 5 is a diagram illustrating a third stage of the separation operation;

FIG. 6 is a diagram illustrating another third stage of the separation operation;

FIG. 7 is a schematic configuration diagram of a separation mechanism which is provided in a paper stacker of a second exemplary embodiment;

FIG. 8 is a diagram illustrating a first stage of a separation operation in the second exemplary embodiment;

FIG. 9 is a diagram illustrating a second stage of the separation operation in the second exemplary embodiment;

FIG. 10 is a diagram illustrating a third stage of the separation operation in the second exemplary embodiment;

FIG. 11 is a diagram illustrating a fourth stage of the separation operation in the second exemplary embodiment;

FIG. 12 is a diagram illustrating a second iteration of the second stage of the separation operation in the second exemplary embodiment;

FIG. 13 is a diagram illustrating another third stage of the separation operation in the second exemplary embodiment;

FIG. 14 is a diagram illustrating another fourth stage of the separation operation in the second exemplary embodiment;

FIG. 15 is a schematic configuration diagram of a displacement mechanism which is provided in a paper stacker of a third exemplary embodiment;

FIG. 16 is a diagram illustrating a first stage of a displacement operation;

FIG. 17 is a diagram illustrating a second stage of the displacement operation; and

FIG. 18 is an enlarged diagram illustrating the second stage of the displacement operation.

### DETAILED DESCRIPTION

Hereinafter, the exemplary embodiments of the invention will be described with reference to the drawings.

### First Exemplary Embodiment

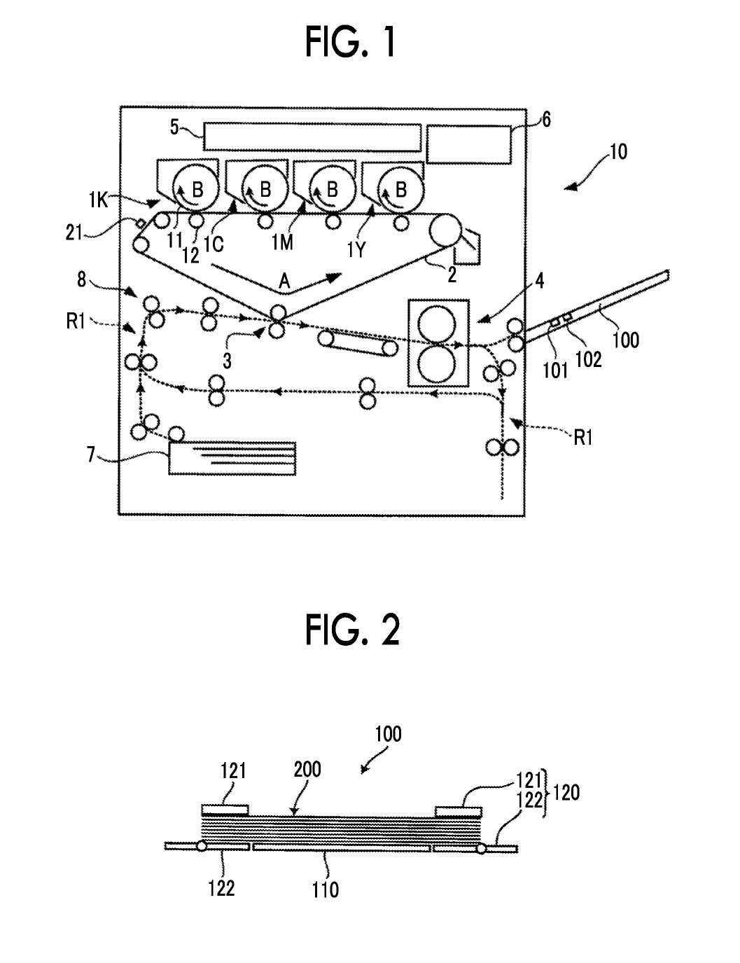

FIG. 1 is a schematic configuration diagram of the printer corresponding to the first exemplary embodiment of the image forming apparatus.

A printer 10 illustrated in FIG. 1 is a tandem type color printer, and also supports so-called duplex printing in which images are formed on both sides of the paper.

An image signal representing an image, which is created outside of the printer 10, is input to the printer 10 via a signal cable or the like (not shown). The printer 10 is provided with a control section 6 which controls the operations of the components in the printer 10, the image signal is input to the control section 6, and a color plate signal representing plural color plates for forming a color image is generated. In the printer 10, image formation is performed under the control of the control section 6.

A paper tray 7 is provided in the bottom portion of the printer 10, and the paper is stored in the paper tray 7 in a stacked state. Although there is a case in which OHP sheets, plastic sheets, or the like are stored in the paper tray 7 as the recording medium instead of paper sheets, hereinafter, description will be given assuming that paper is stored in the paper tray 7.

In the printer 10, four image engines 1K, 1C, 1M, and 1Y are disposed to line up, and the image engines 1K, 1C, 1M, and 1Y form toner images of K (black), C (cyan), M (magenta), and Y (yellow), respectively, on a photoreceptor 11. One exposing device 5 is provided for the four image engines 1K, 1C, 1M, and 1Y. The exposing device 5 receives the color plate signal of each of the K color, the C color, the M color, and the Y color from the control section 6, and renders an image of each color plate on the photoreceptor 11 of each image engine using light exposure. In each of the image engines 1K, 1C, 1M, and 1Y, the image of each rendered color plate is developed using the toner of each color K, C, M, or Y, and the toner image is formed.

An intermediate transfer belt 2 is provided in the printer 10, and moves by circulating in an arrow A direction along a circulation path which passes through the four image engines 1K, 1C, 1M, and 1Y. The photoreceptor 11 of each image engine rotates in an arrow B direction, and a primary transfer unit 12 is disposed to nip the intermediate transfer belt 2 between each photoreceptor 11 and the primary transfer unit 12. The toner image on the photoreceptor 11 is sequentially transferred onto the intermediate transfer belt 2 by the primary transfer units 12 such that the toner image of each color overlaps the others. As a result, a color toner image is formed on the intermediate transfer belt 2. A density sensor 21 is disposed to oppose the surface of the intermediate transfer belt 2, and the density of the toner image (the amount of toner per unit area) is measured by the density sensor 21. The density sensor 21 corresponds to an example of an image amount detector.

A secondary transfer unit 3 is provided in the circulation path of the intermediate transfer belt 2, and the toner image on the intermediate transfer belt 2 moves with the circulation movement of the intermediate transfer belt 2 to reach the secondary transfer unit 3.

A paper transporter 8 which transports the paper is provided between the paper tray 7 and the intermediate transfer belt 2 which are described above, the paper is removed from the paper tray 7 by the paper transporter 8, and is transported along a first transport path R1 to the secondary transfer unit 3. The toner image is transferred onto the paper by the secondary transfer unit 3. The paper onto which the toner image is transferred is further transported by the paper transporter 8 to reach a fixing unit 4 which is provided in the first transport path R1. In the fixing unit 4, the paper is subjected to pressurization and heating, and the toner image is fixed onto the paper by the melting of the toner. The paper transporter 8 includes a second transport path R2, and in the case of duplex printing, after the fixing of the paper for which the image formation onto one side is finished, the paper is reversed, obverse for reverse, by being transported along the second transport path R2, and is returned to the upstream of the first transport path R1.

A component in which the elements from the four image engines 1K, 1C, 1M, and 1Y to the secondary transfer unit 3 are combined corresponds to an example of a forming device, and the fixing unit 4 corresponds to an example of a fixing unit.

A paper stacker 100 is provided in the printer 10, and the paper onto one or both sides of which an image is formed and fixed is transported and stacked in the paper stacker 100 by the paper transporter 8. The paper stacker 100 is provided with a temperature sensor 101 and a paper amount sensor 102. The temperature sensor 101 detects the temperature of the stacked paper, and the paper amount sensor 102 detects the amount (the number of sheets) of the stacked paper by pressure or the like, for example. The paper stacker 100 corresponds to the first exemplary embodiment of the medium stacking device, the temperature sensor 101 corresponds to an example of a temperature detector, and the paper amount sensor 102 corresponds to an example of a medium amount detector.

A separation mechanism for suppressing the print blocking is embedded in the paper stacker 100. Hereinafter, detailed description will be given of the separation mechanism.

FIG. 2 is a schematic configuration diagram of the separation mechanism which is provided in the paper stacker.

FIG. 2 schematically illustrates the paper stacker 100 in a state of being viewed from the right side of FIG. 1.

The paper stacker 100 is provided with a stacking tray 110 and separation mechanisms 120. The paper is stacked on the stacking tray 110, the separation mechanisms 120 separate a stacked member 200 formed of the paper which is stacked on the stacking tray 110, and each of the separation mechanisms 120 is provided with a retainer 121 and a bender 122. One set of the retainer 121 and the bender 122 is provided on each side to interpose the stacking tray 110, and operates according to the instructions of the control section 6 illustrated in FIG. 1. Note that, although description of the specific drive mechanism which causes the retainers 121 and the benders 122 to operate is omitted here, the retainers 121 and the benders 122 are driven by known driving components such as motors and solenoids. The separation mechanisms 120 correspond to an example of a displacer.

The stacking tray 110 is equivalent to an example of a stacking tray.

When the paper on one or both sides of which the toner image is formed is transported to the stacking tray 110, the paper is sequentially piled onto the stacking tray 110 to form the stacked member 200. Both ends of the stacked member 200 assume a state of being interposed between the retainer 121 and the bender 122. At this time, the retainers 121 apply no force to the stacked member 200, and are simply positioned at both ends of the stacked member 200.

Then the starting conditions (described later in detail) are established, the separation operation in which the stacked member 200 is separated is started. Leaving the description of the starting conditions for later, hereinafter, detailed description will first be given of the separation operation.

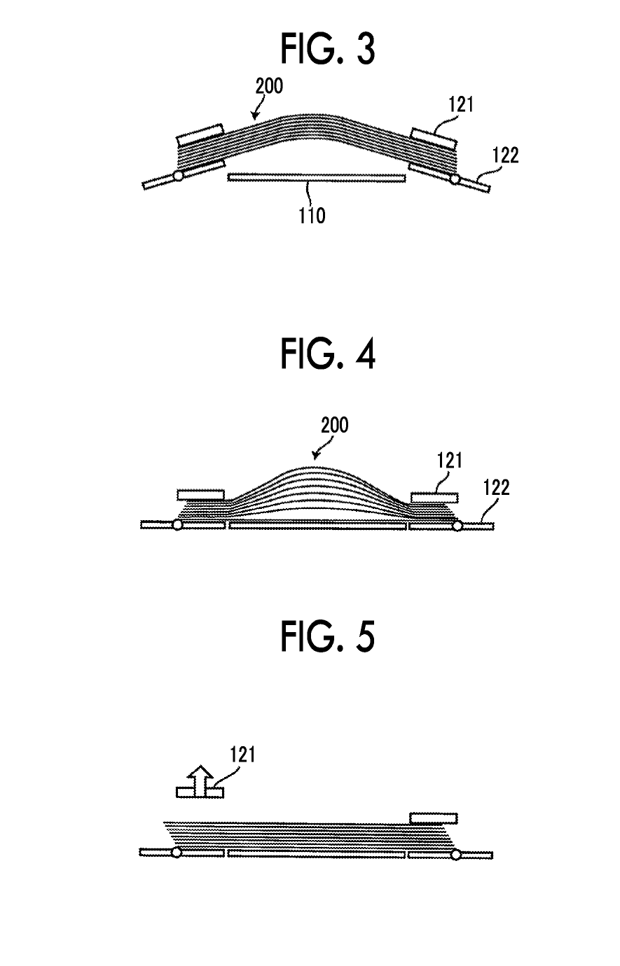

FIGS. 3 to 6 are diagrams illustrating the separation operation.

In the first stage illustrated in FIG. 3, by the retainers 121 and the benders 122 rotating, the stacked member 200 is bent to lift up from the stacking tray 110. Due to the stacked member 200 being bent in this manner, since the sheets of paper of the stacked member 200 move such that the positions thereof are shifted slightly relative to each other, the sheets of paper are caused to move relative to each other in a single operation. Although the relative movement in the first stage occurs with the sheets of paper still in contact with each other, since the contact positions are shifted, the sticking of the sheets to each other is suppressed.

Next, in the second stage illustrated in FIG. 4, both ends of the stacked member 200 are strongly retained by the retainers 121, and, the retainers 121 and the benders 122 rotate in reverse from the first stage with the stacked member 200 still in the retained state, and the bending of the stacked member 200 is stretched out. Accordingly, gaps are formed between the sheets of paper of the stacked member 200, and the sheets of paper of the stacked member 200 are all spread out at once.

Subsequently, in the third stage illustrated in FIG. 5, one of the retainers 121 is lifted up, and the sheets of paper of the stacked member 200 return to a flat state.

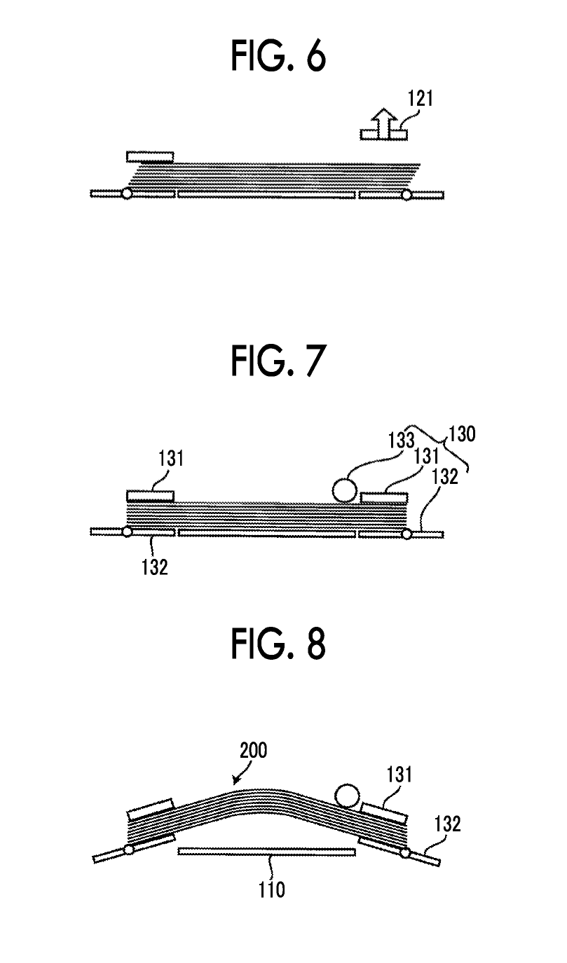

Subsequently, when the starting conditions are established once more, the first stage illustrated in FIG. 3 and the second stage illustrated in FIG. 4 are repeated. Next, in the other third stage illustrated in FIG. 6, the opposite retainer 121 from the retainer which is lifted up in FIG. 5 is lifted up. In the third stage, offsetting of the stacked member 200 is prevented by the retainers 121 of both sides being lifted up alternately in this manner in the third stage.

Here, description will be given of the starting conditions of the separation operation.

For example, the separation operation may be executed each time a predetermined number of sheets are printed, after a predetermined time interval, or the like; however, in the present exemplary embodiment, in order to more efficiently suppress the print blocking by reducing the number of times the separation mechanisms 120 are operated, starting conditions are adopted based on the detection results of the temperature sensor 101 or the paper amount sensor 102. In other words, the separation operation is started when at least one of a high temperature condition and a many stacked condition is established. In the high temperature condition, the temperature of the stacked member 200 which is detected by the temperature sensor 101 is high, and in the many stacked condition there are many sheets of paper of the stacked member 200 which are detected by the paper amount sensor 102. This is because, the print blocking occurs more easily the higher the temperature of the stacked member 200, and the print blocking occurs more easily the more sheets of paper of the stacked member 200 are present.

Here, the high temperature condition is a condition in which the satisfied case is a higher temperature than the non-satisfied case. For example, various conditions are conceivable in relation to a predetermined threshold temperature, such as a condition in which a one-time temperature detection value is greater than or equal to the threshold, a condition in which an average value of detected temperatures which are detected in succession a predetermined number of times is greater than or equal to the threshold, a condition in which the maximum value of the detected temperatures is greater than or equal to the threshold, or a condition in which the minimum value of the detected temperatures is greater than or equal to the threshold. The high temperature condition which is actually adopted is determined based on design principles and the like; however, in the present exemplary embodiment, the high temperature condition is adopted in which, simply, the one-time temperature detection value is greater than or equal to the threshold.

The many stacked condition is a condition in which the satisfied case is a larger number of stacked sheets of paper than the non-satisfied case. For example, various conditions are conceivable in relation to a predetermined threshold, such as a condition in which a one-time paper amount detection value is greater than or equal to the threshold, a condition in which an average value of detected values which are detected in succession a predetermined number of times is greater than or equal to the threshold, a condition in which the maximum value of the detected values is greater than or equal to the threshold, or a condition in which the minimum value of the detected values is greater than or equal to the threshold. The many stacked condition which is actually adopted is determined based on design principles and the like; however, in the present exemplary embodiment, the many stacked condition is adopted in which, simply, the one-time paper amount detection value is greater than or equal to the threshold.

In the starting conditions of the present exemplary embodiment, the thresholds of each of the high temperature condition and the many stacked condition are changed to thresholds corresponding to the amount of the toner (the image density) which forms the image on the paper. This is because, the higher the image density, the more easily the print blocking occurs. The image density is measured by the density sensor illustrated in FIG. 1, and, specifically, the values illustrated in Table 1 below are used as the thresholds.

TABLE 1

| Image Density | | Stacking Amount |
|---|---|---|
| (g/m²) | Temperature (° C.) | (sheets) |
| 4 | 60 | 200 |
| 5 | 58 | 190 |
| 6 | 56 | 180 |
| 7 | 54 | 170 |
| 8 | 52 | 160 |
| 9 | 50 | 150 |
| 10 | 48 | 140 |

The thresholds of the image density and the temperature and the thresholds of the stacking amount (the paper amount) are denoted in association with each other lined up in rows in Table 1. For example, when the image density is 7 g/m², the threshold of the high temperature condition is 54° C., and the threshold of the many stacked condition is 170 sheets. The higher the image density, the lower the temperature of the threshold of the high temperature condition becomes, and the lesser the threshold of the many stacked condition becomes. The separation mechanisms 120 operate appropriately according to the type of the toner image due to the high temperature condition and the many stacked condition which are associated with the image density in this manner being used. Note that, the correspondence between the image density and the high temperature condition (the threshold of the temperature) and the many stacked condition (the threshold of the stacking amount) is not limited to a discrete correspondence as illustrated in table 1, and may be a continuous correspondence. For example, correspondence by an equation (1), or an equation (2) is conceivable.

4−image density=(temperature−60)/2 (1)

4−image density=(stacking amount−200)/10 (2)

The description of the first exemplary embodiment above is finished, and next, description will be given of the second exemplary embodiment.

### Second Exemplary Embodiment

Since the second exemplary embodiment is the same as the first exemplary embodiment except in that the separation mechanism differs, description will be given focusing on the differences, and duplicated description will be omitted.

FIG. 7 is a schematic configuration diagram of the separation mechanism which is provided in the paper stacker of the second exemplary embodiment.

In the second exemplary embodiment, separation mechanisms 130 are provided with retainers 131, benders 132, and a roller 133. Of these elements, the retainers 131 and the benders 132 are the same elements as the retainers 121 and the benders 122 in the first exemplary embodiment. The starting conditions of the separation operation by the separation mechanisms 130 are the same as in the first exemplary embodiment. The separation mechanisms 130 also correspond to an example of the displacer.

Hereinafter, description will be given of the separation operation in the second exemplary embodiment.

FIGS. 8 to 14 are diagrams illustrating the separation operation in the second exemplary embodiment.

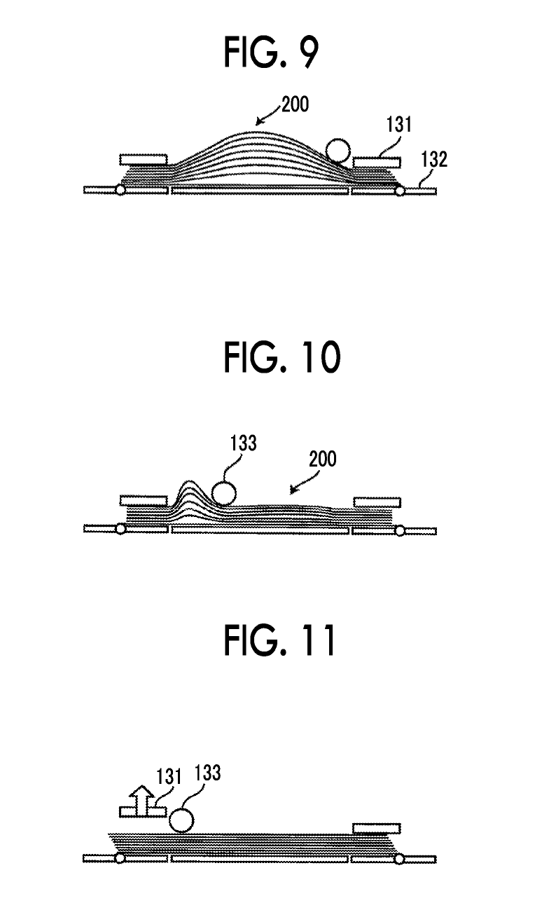

In the first stage illustrated in FIG. 8, the stacked member 200 is bent to lift up from the stacking tray 110 by the retainers 131 and the benders 132 rotating in the same manner as in the first exemplary embodiment. In the same manner as in the first exemplary embodiment, in the second stage illustrated in FIG. 9, the retainers 131 and the benders 132 rotate in reverse from the first stage, and the bending of the stacked member 200 is stretched out.

Next, in the third stage illustrated in FIG. 10, the roller 133 moves from one end to the other end while retaining the stacked member 200. According to the movement of the roller 133, gaps even form in locations at which the gaps did not previously form between the sheets of paper in the second stage, and the separation properties between the sheets of paper are strengthened in the second exemplary embodiment.

In the fourth stage illustrated in FIG. 11, of the retainers 131 on each side, the retainer 131 toward which the roller 133 moves in the third stage is lifted up, and the sheets of paper of the stacked member 200 return to a flat state.

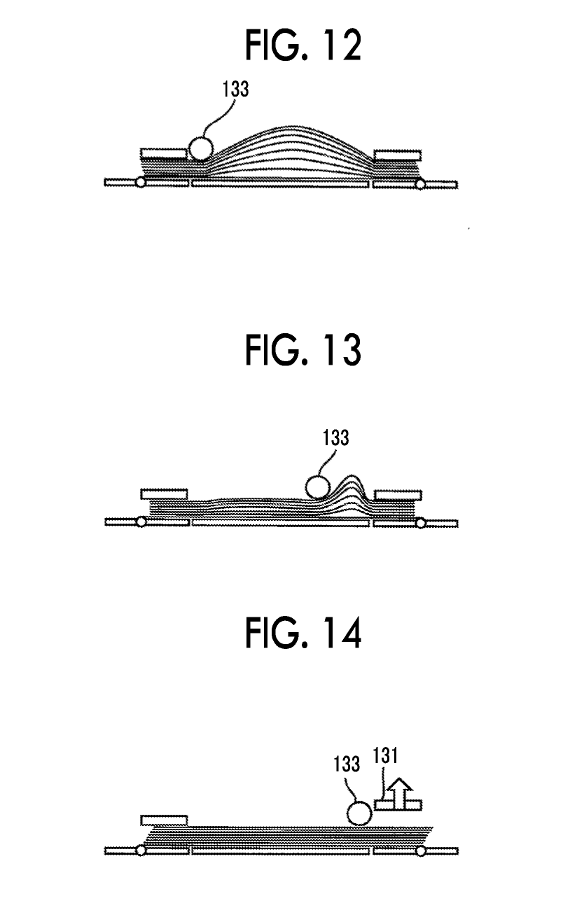

Subsequently, when the starting conditions are established once more, the first stage illustrated in FIG. 8 and the second stage illustrated in FIG. 9 are repeated, and the state illustrated in FIG. 12 is assumed. In the other third stage illustrated in FIG. 13, the roller 133 moves in the opposite direction from in FIG. 10, and in the other fourth stage illustrated in FIG. 14, the opposite retainer 131 from the retainer which is lifted up in FIG. 11 is lifted up.

The description of the second exemplary embodiment above is finished, and next, description will be given of the third exemplary embodiment.

### Third Exemplary Embodiment

Since the third exemplary embodiment is the same as the first exemplary embodiment except in that the paper is displaced using a displacement mechanism which differs from the separation mechanism, description will be given focusing on the differences, and duplicated description will be omitted.

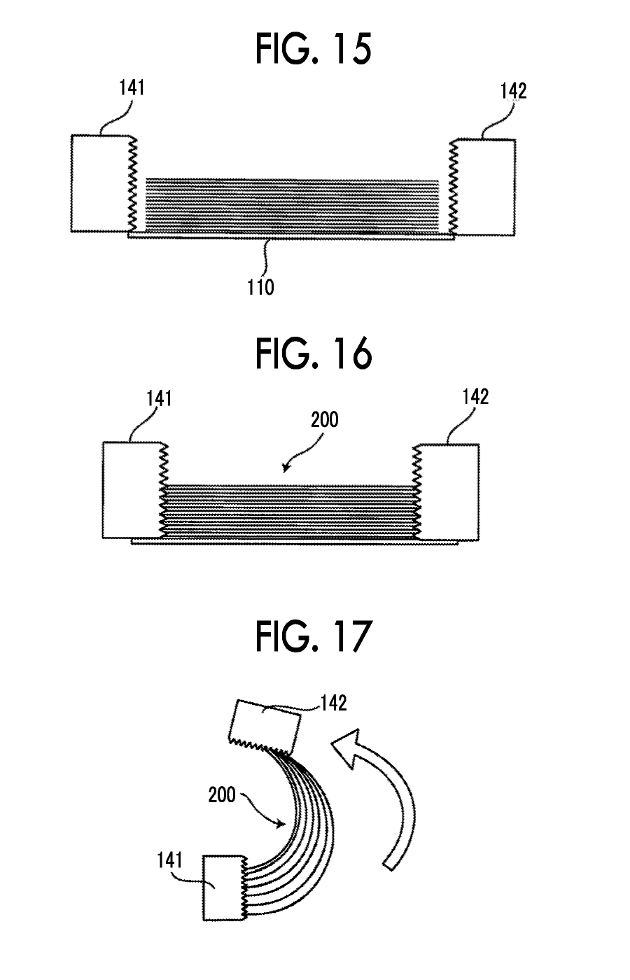

FIG. 15 is a schematic configuration diagram of the displacement mechanism which is provided in the paper stacker of the third exemplary embodiment.

In the third exemplary embodiment, a displacement mechanism which is provided with a first holder 141 and a second holder 142 is adopted, and the stacking tray 110 is positioned between the holders 141 and 142. The holders 141 and 142 operate according to the instructions of the control section 6 illustrated in FIG. 1. Although description of the specific drive mechanism which causes the holders 141 and 142 to operate is also omitted here, the holders 141 and 142 are driven by known driving components such as motors and solenoids. The displacement mechanism provided with the holders 141 and 142 corresponds to an example of a displacer.

When the paper is transported to and stacked on the stacking tray 110, the holders 141 and 142 are separated from each other by the paper width or greater. When the same starting conditions as the starting conditions in the first exemplary embodiment are established, the displacement operation described hereinafter is executed in the third exemplary embodiment.

FIGS. 16 to 18 are diagrams illustrating the displacement operation.

When the displacement operation is started, in the first stage illustrated in FIG. 16, the first holder 141 and the second holder 142 interpose and hold the stacked member 200 from both sides.

Next, in the second stage illustrated in FIG. 17, of the two holders 141 and 142, the second holder 142 is lifted up as though drawing an arc to bend the stacked member 200. Since the sheets of paper of the stacked member 200 move such that the positions thereof are shifted slightly relative to each other even when the stacked member 200 is bent in this manner, the sheets of paper are caused to move relative to each other in a single operation.

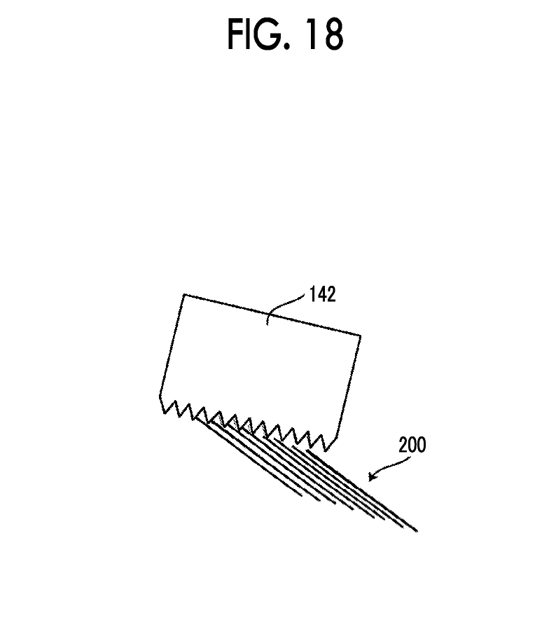

As illustrated in the enlarged diagram in FIG. 18, since the separation occurs sequentially from the paper of the bottom side of the stacked member 200 from the second holder 142, the sheets of paper of the stacked member 200 easily spread out sheet by sheet, and the print blocking is suppressed.

Note that, in the above description, a density sensor which detects the image density on the intermediate transfer belt is illustrated as an example of the image amount detector; however, the image amount detector may detect the image density on the recording medium, or may detect the image density based on the image data.

In the above description, both the high temperature condition and the many stacked condition are used to execute the separation operation and the displacement operation; however, the operations of the displacer may be controlled using only the high temperature condition or the many stacked condition, and the operations of the displacer may be controlled without using either of the high temperature condition or the many stacked condition, as described above. In the above description, an example is illustrated in which the high temperature condition and the many stacked condition are associated with the image density; however, the operations of the displacer may be controlled using the high temperature condition or the many stacked condition which are fixed without being associated with the image density.

In the above description, a tandem type color printer is exemplified; however, the invention may be adapted for a monochrome-only apparatus, and may be adapted for a facsimile, a copier, or a multi-functional machine.

In the above description, an apparatus which supports duplex printing in which the print blocking occurs easily is exemplified; however, the invention may be adapted for an apparatus which only supports simplex printing.

In the above description, an apparatus which forms a toner image using the electrophotographic process is exemplified; however, the forming device may render the toner image on the recording medium using a process other than the electrophotographic process.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus, comprising:
a forming device that forms unfixed images on recording media;
a fixing unit that melts a material forming the images to fix the images onto the recording media;
a stacking tray on which the recording media onto which the images are fixed are stacked; and
a displacer that applies a force to the recording media stacked on the stacking tray to displace the recording media relative to each other.

2. The image forming apparatus according to claim 1,
wherein the displacer displaces the recording media relative to each other by bending a stacked member in which a plurality of recording media are stacked.

3. The image forming apparatus according to claim 2,
wherein the displacer forms gaps between the plurality of recording media by gripping a plurality of locations in the bent stacked member, the locations being separated from each other, and by stretching out the bent stacked member.

4. The image forming apparatus according to claim 2,
wherein the displacer bends the stacked member by pressing a member into a side surface of the stacked member and pushing up the side surface with the member, and causes the plurality of recording media which form the stacked member to individually separate from the member.

5. The image forming apparatus according to claim 1, further comprising:
a temperature detector that detects a temperature of the recording media stacked on the stacking tray,
wherein the displacer displaces the recording media on the stacking tray relative to each other according to the temperature detected by the temperature detector.

6. The image forming apparatus according to claim 5, further comprising:
an image amount detector that detects an amount of a material forming the image,
wherein the displacer displaces the recording media on the stacking tray relative to each other according to an amount of the material detected by the image amount detector and the temperature detected by the temperature detector.

7. The image forming apparatus according to claim 1, further comprising:
a medium amount detector that detects an amount of the recording media stacked on the stacking tray,
wherein the displacer displaces the recording media on the stacking tray relative to each other according to the amount of recording media detected by the medium amount detector.

8. The image forming apparatus according to claim 7, further comprising:
an image amount detector that detects an amount of a material forming the image,
wherein the displacer displaces the recording media on the stacking tray relative to each other according to the amount of the material and the amount of recording media detected by the medium amount detector.

9. A medium stacking device, comprising:
a stacking tray on which recording media, onto which images are fixed by melting a material forming the images, are stacked; and
a displacer that applies a force to the recording media on the stacking tray to displace the recording media relative to each other.
